(19) United States
(12) Patent Application Publication
(10) Pub. No.: US 2011/0151223 A1
(43) Pub. Date: Jun. 23, 2011

(54) PROTECTIVE FILM

(75) Inventors: Chong Won Kim, Gumi-si (KR); Suk Won Choi, Busan (KR); Si Min Kim, Daegu-si (KR); Jung-Seok Kim, Anyang-si (KR); Sang-Hyun Baek, Gumi-si (KR)

(73) Assignee: KOLON INDUSTRIES, INC., Gwacheon-si, Gyeonggi-do (KR)

(21) Appl. No.: 12/995,140

(22) PCT Filed: May 27, 2009
(86) PCT No.: PCT/KR2009/002812

§ 371 Date: Mar. 3, 2011

(30) Foreign Application Priority Data
May 29, 2008 (KR) 10-2008-0050009
Oct. 24, 2008 (KR) 10-2008-0104669
Oct. 24, 2008 (KR) 10-2008-0104679

(51) Int. Cl. B32B 7/02; B32B 17/06

(52) U.S. Cl. 428/216; 428/336; 428/426

(57) ABSTRACT

The present invention relates to a protective film formed by stacking two or more sheets of transparent plastic bases having functional coating layers by means of an adhesive layer.

### TECHNICAL FIELD

The present invention relates to a protective film on which a transparent plastic substrate formed with a functional coating layer is stacked by an adhesive layer.

In addition, the present invention relates to a protective film for an e-book to which a touch screen scheme is applied.

### BACKGROUND ART

An e-paper, which implies a display having characteristics similar to a general paper, is a next-generation display capable of freely writing, erasing, and storing data as well as displaying simple information.

The e-book using a principle of the e-paper has also been developed. The e-book is configured to include a driving film formed on glass and a protective film protecting the driving film.

In addition, with the development of an e-book industry, an e-book having a function capable of freely writing, erasing, and storing data as well as displaying simple information has been demanded. In order to more easily use these functions, a touch screen scheme has been applied to the e-book. The e-book to which the touch screen scheme is applied requires a protective film to be stably and robustly operated even in polluted environment.

Therefore, the protective film protecting the e-book or the e-book to which the touch screen scheme is applied requires physical properties that can release the shock and withstands moisture and UV. A need exists for the development of the protective film.

### DISCLOSURE

### Technical Problem

An object of the present invention is to provide a protective film used for an e-book with excellent moisture resistance, UV barrier property.

Another object of the present invention is to provide a protective film having a scratch preventing function and antiglare function.

Another object of the present invention is to provide a protective film used for an e-book to which a touch screen is applied.

### Technical Solution

The present invention relates to a protective film used for an e-book, and more particularly, to a protective film on which at least two sheets of transparent plastic substrate formed with a functional coating layer are stacked. In particular, the present invention has a feature in terms of a stacked sequence and prevents antiglare and the occurrence of scratch by forming an antiglare layer on an outermost layer.

In addition, the inventors found that the present invention stacks a first silicon oxide coating layer in a film and further stacks a second silicon oxide coating layer therein to provide a protective film with improved moisture permeability to be suitably used for an e-book.

In addition, the protective film of the present invention has a feature in terms of the stacked sequence and the thickness thereof. The inventors found that the present invention controls the thickness of each layer to be in a specific range to provide a protective film with improved moisture permeability. The protective film manufactured by the stacked sequence and the thickness of the present invention has 0.5 g/m²·day or less of moisture permeability under the condition (KSM 3088:2004) of 38±2° C., 100% R.H and 2.0% or less of UV light transmittance.

The protective film according to the present invention can implement low aging of electronic ink and antiaging of the film while having the moisture permeability suitable for the e-book.

Hereinafter, the present invention will be described in detail with reference to the accompanying drawings. The accompanying drawings show only one example for explaining in detail the present invention and the present invention is not limited thereto.

As shown in FIG. 1, a first detailed embodiment of the present invention, a protective film includes: an antiglare coating layer 11 formed on one surface of a first transparent plastic substrate 10, a first silicon oxide (SiOx, x is 1.0 to 2.0) coating layer 21 formed on one surface of a second transparent plastic substrate 20, and an adhesive layer having the first transparent plastic substrate 10 and the first silicon oxide coating layer 21 disposed to be opposite to each other thereon and bonded to each other therethrough.

As shown in FIG. 2, a second detailed embodiment of the present invention further includes a protective coating layer 22 on the protective film of the first exemplary embodiment. In detail, according to a second detailed embodiment of the present invention, a protective film includes: an antiglare coating layer 11 formed on one surface of a first transparent plastic substrate 10, a first silicon oxide (SiOx, x is 1.0 to 2.0) coating layer formed on one surface of a second transparent plastic substrate 20, a protective coating layer 22 made of acrylic resin formed on the upper portion of the first silicon oxide coating layer 21, and an adhesive layer 100 having the transparent plastic substrate 10 and the protective coating layer 22 disposed to be opposite to each other thereon and bonded to each other therethrough. The protective coating layer 22 may be formed, if necessary, which is coated at a thickness of 0.01-5 μm.

A third detailed embodiment of the present invention further includes a second silicon oxide (SiOx, x is 1.0 to 2.0) coating layer 23 on the protective film of the first detailed embodiment, as shown in FIG. 3. In detail, according to a third detailed embodiment of the present invention, a protective film includes an antiglare coating layer 11 formed on one surface of the first transparent plastic substrate 10, a first silicon oxide (SiOx, x is 1.0 to 2.0) coating layer 21 formed on one surface of a second transparent plastic substrate 20, a second silicon oxide (SiOx, x is 1.0 to 2.0) coating layer 23 formed on an opposite surface thereto, and an adhesive layer 100 having the first transparent plastic substrate 10 and the first silicon oxide coating layer 21 disposed to be opposite to each other thereon and bonded to each other therethrough.

A fourth detailed embodiment of the present invention further includes a conductive coating layer 32 on the protective film of the third exemplary embodiment, as shown in FIG. 4. In detail, according to a fourth detailed embodiment of the present invention, a protective film includes an antiglare coating layer 11 formed on one surface of a first transparent plastic substrate 10, a first silicon oxide (SiOx, x is 1.0 to 2.0) coating layer formed on one surface of a second transparent plastic substrate 20, a second silicon oxide (SiOx, x is 1.0 to 2.0) coating layer 23 formed on an opposite surface thereto, an adhesive layer 100 having the first transparent plastic substrate 10 and the first silicon oxide coating layer 21 disposed to be opposite to each other thereon and bonded to each other therethrough, and a conductive coating layer 32 formed on the second silicon oxide (SiOx, X is 1.0-2.0) coating layer 23 of the protective film. The conductive coating layer 32 may be formed, if necessary and it is coated with indium tin oxide (ITO) at a thickness of 200 to 1000 Å by a method selected from a sputtering method, a vacuum deposition method, an ion plating method, a coating method, a solution coating method, and a powder coating method.

A fifth detailed embodiment of the present invention further includes the conductive coating layer 32 on the protective film of the first exemplary embodiment, as shown in FIG. 5. In detail, according to a fifth detailed embodiment of the present invention, a protective film includes: an antiglare coating layer 11 formed on one surface of a first transparent plastic substrate 10, a first silicon oxide (SiOx, x is 1.0 to 2.0) coating layer formed on one surface of a second transparent plastic substrate 20, an adhesive layer 100 having the first transparent plastic substrate 10 and the first silicon oxide coating layer 21 disposed to be opposite to each other thereon and bonded to each other therethrough, and a conductive coating layer 32 formed on the second transparent plastic substrate 20 of the protective film. The conductive coating layer 32 may be formed, if necessary and it is coated with indium tin oxide (ITO) at a thickness of 200 to 1000 Å by a method selected from a sputtering method, a vacuum deposition method, an ion plating method, a coating method, a solution coating method, and a powder coating method.

A sixth exemplary embodiment of the present invention further includes the conductive coating layer 32 on the protective film of the second exemplary embodiment, as shown in FIG. 6. In detail, the sixth exemplary embodiment of the present invention relates to a protective film in which the antiglare coating layer 11 is formed on one surface of the first transparent plastic substrate 10, the first silicon oxide (SiOx, x is 1.0 to 2.0) coating layer 21 is formed on one surface of a second transparent plastic substrate 20, a protective coating layer 22 made of acrylic resin is further formed on the upper portion of the first silicon oxide coating layer 21, a protective coating layer 22 is disposed to be opposite to the first transparent plastic substrate 10, and the conductive coating layer 32 is formed on the second transparent plastic substrate 20 of the protective film bonded by the adhesive layer 100. The conductive coating layer 32 may be formed, if necessary and it is coated with indium tin oxide (ITO) at a thickness of 200 to 1000 Å by a method selected from a sputtering method, a vacuum deposition method, an ion plating method, a coating method, a solution coating method, and a powder coating method.

Hereinafter, the configuration of the present invention will be described in more detail.

In the present invention, the first transparent plastic substrate 10 and the second transparent plastic substrate 20 may use a plastic material having 90% or more of light transmittance. For example, polyethyleneterephthalate resin, polyethylenenaphatalate resin, or the like, can be used. In addition, stretched reins may be used.

The first transparent plastic substrate 10 serves as a support of the protective film but is not limited thereto. When the thickness of the first transparent plastic substrate 10 is 50 to 250 μm, preferably, 100 to 188 μm, it can maintain flexibility while having the sufficient thickness as the support, without damaging the appearance.

The second transparent plastic substrate 20 is not limited as serving as the support of the silicon oxide coating. When the thickness of the second transparent plastic substrate 20 is 10 to 50 μm, more preferably, 12 to 30 μm, it is suitable to perform the function of the support in the oxide depositing process without damaging the appearance such as wrinkle, etc.

In the present invention, the antiglare coating layer 11 may be made of a composition in which silicon bead, or the like, is added to hard resin such as acrylurethane-based resin, siloxane-based resin, or the like, which can achieve the antiglare effect and the scratch preventing effect. If the thickness of the antiglare coating layer 11 is thin, the hardness of the antiglare coating layer 11 may be insufficient and if the thickness thereof is excessive thick, cracks may occur. In addition, in order to prevent a curl from occurring, it is preferable that the thickness of the antiglare coating layer 11 is 3 to 5 μm.

In the present invention, the first silicon oxide coating layer 21 or the second silicon oxide coating layer may be formed by a vacuum deposition method. The silicon oxide (SiOx, X is 1.0 to 2.0) coating layer has low transparency if x value is less than 1.0, such that the light transmittance is 90% or less. On the other hand, if x value exceeds 2.0, cracks may occur. Therefore, it is preferable that the x value is in the range of 1.0 to 2.0. The thickness of the silicon oxide coating layer is 300 to 1000 Å, more preferably, 400 to 800 Å, which can maintain excellent moisture resistance and transparent color.

In the protective film of the present invention, the adhesive layer 100 is an adhesive composition made of acrylic resin. Preferably, the adhesive composition includes a UV screening agent. The adhesive layer 100 of the present invention may have 90% or more of light transmittance, 1% or less of Haze, and 10³-10⁵ Pa of shear storage elastic modulus. If the light transmittance of the adhesive layer is 90% or less or the Haze thereof is 1% or less, sharpness is deteriorated during the display. Meanwhile, if the shear storage elastic modulus is less than 10³ Pa, the adhesive layer sticks out during the punching, which leads to a problem of assembling products and if the shear storage elastic modulus exceeds 10⁵ Pa, the adhesion is deteriorate, which degrades durability and weakens a shock absorbing function.

In addition, the adhesive composition may further include 0.5 to 5 parts by weight of triazole-based UV screening agent for a solid of resin in order to secure a wide range of UV screening function. If the content of the triazole-based UV screening agent is less than 0.5 parts by weight, the UV transmittance is sharply increased after the QUV test and thus, the driving layer of the e-book is damaged, such that the response speed may be slow. On the other hand, the content thereof exceeds 5 parts by weight, the color value may be changed after the QUV test. In addition, a triazine-based UV screening agent, an antioxidant, a heat stabilizer, a fluorescent whitening agent, etc., all of which are generally used in the art, may be further added, if necessary. The content thereof may be added within the range in which physical properties of the film are not degraded. Preferably, they may be further added by 0.5 to 5 parts by weight for the solid of resin.

The adhesive composition used for the adhesive layer of the present invention may further include a crosslinker in addition to acrylic resin. The adhesive layer may have the improved heat resistance and water resistance by being subjected to a crosslinking by a combination of crosslinkers. It is preferable to use the crosslinker having the reactivity with the functional group of acrylic resin. An example of the crosslinker may include peroxide, isocyanate-based crosslinker, epoxy-based crosslinker, metal chelate crosslinker, melamine-based crosslinker, aziridin-based crosslinker, metal salt, or the like. These crosslinkers may be used alone or a mixture of two or more thereof may be used. Among these crosslinkers, it is preferable to use the isocyanate-based crosslinker in terms of adhesion. The isocyanate crosslinker may include a diisocyanates such as tolrilrendiisocyanate, diphenyl methane diisocyanate, xylene diisocyanate, isophorone diisocyanate, hexamethylene diisocyanate, and the like or a polyisocyanate compound generated by diisocyanate byproduct denatured by various polyols and isocyanurate ring, biuret, or allophanate. Further, since a cured adhesive layer may be colored, in the case of an aromatic isocyanate compound, an aliphatic or cycloaliphatic isocyanate compound is preferably used as the isocyanate crosslinker for the purpose of transparency. The mixture amount of the crosslinker is generally in the range of 0.01 to 10.0 parts by weight, preferably 0.05 to 5.0 parts by weight for acrylic adhesive agent 100 parts by weight. When the mixture amount of the crosslinker is larger than 10.0 parts by weight, crosslink is excessive, such that a tack property is deteriorated after a drying process. Therefore, an adhesive property is deteriorated after lamination with the transparent plastic substrate to deteriorate durability and when the mixture amount of the crosslinker is less than 0.01 parts by weight, hardness is decreased to deteriorate water resistance.

The adhesive layer 100 is manufactured by applying and drying the adhesive composition on the support. Since the adhesive agent contains the crosslinker, crosslinking is performed by appropriate heat treatment. The crosslinking may be jointly performed at a temperature of a drying process of a solvent and may be performed by forming an additional crosslinking process after the drying process. The adhesive layer may be aged for the purpose of adjusting crosslinking reaction.

In the present invention, the adhesive layer 100 functions to improve a shock absorbing property between the first transparent plastic substrate and the second transparent plastic substrate. The adhesive layer 100 has the shear storage elastic modulus of 10³ to 10⁵ Pa in order to show the function more efficiently.

The adhesive composition used in the adhesive layer of the present invention may be manufactured by a liquid composition. Examples of the used solvents include methylethylketone, acetone, ethyl acetate, tetra hydrofuran, dioxane, cyclohexanone, n-hexane, toluene, xylene, methanol, ethanol, n-propanol, isopropanol, water, and the like. The solvents may be used alone and as a mixture of two or more of the solvents. Polymerized solvents may be used as the solvents and in addition, one or more solvents may be newly added in addition to the polymerized solvents for uniform coating of the adhesive layer.

The present invention may form the protective coating layer 22 on the first silicon oxide coating layer 21. The protective coating layer 22 uses acrylic resin that has good adhesion with silicon oxide and excellent scratch resistance. The coating thickness of the protective coating layer 22 is in the range 0.01 to 5 μm, preferably, 0.1 to 3 μm. When the protecting coating layer 22 is used in the above range, the moisture permeability may be lowered by not increasing Haze and generating the scratch. The acrylic resin used in the protective coating layer uses a resin having 70° C. or more of glass transition temperature. If the glass transition temperature is less than 70° C., blocking may occur when the film manufactured in a roll shape after the coating process is stored.

In the present invention, the conductive coating layer 32 is given with conductivity in order to show a touch screen function when the protective film of the present invention is applied to the e-book. Indium tin oxide (ITO) may be formed by a sputtering method, a vacuum deposition method, an ion plating method, a coating method, a solution coating method, a powder coating method, and the like. The method is not limited thereto and the sputtering is preferably used.

Further, the conductive coating layer 32 preferably as a thickness in the range of 200 to 1000 Å and more preferably has a thickness in the range of 300 to 800 Å. When the touch screen operates in the range of 200 to 1000 Å, an electrical signal is smoothly transferred and transparency is not deteriorated. Therefore, when the protective film is mounted on a final product, the resolution of the display may be expressed.

### Advantageous Effects

Since the protective film of the present invention has low moisture permeability, the protective film can minimize temporal variation of electronic ink when it is adopted as a protective film of an e-book and further, since the protective film of the present invention has low UV transmittance, the protective film can prevent a driving film from being aged.

### DESCRIPTION OF DRAWINGS

The above and other objects, features and advantages of the present invention will become apparent from the following description of preferred embodiments given in conjunction with the accompanying drawings, in which:

FIG. 1 shows a first detailed embodiment of a protective film according to the present invention;

FIG. 2 shows a second detailed embodiment of a protective film according to the present invention;

FIG. 3 shows a third detailed embodiment of a protective film according to the present invention;

FIG. 4 shows a fourth detailed embodiment of a protective film according to the present invention;

FIG. 5 shows a fifth detailed embodiment of a protective film according to the present invention;

FIG. 6 shows a sixth detailed embodiment of a protective film according to the present invention;

### DETAILED DESCRIPTION OF MAIN ELEMENTS

10: FIRST TRANSPARENT PLASTIC SUBSTRATE
11: ANTIGLARE COATING LAYER
20: SECOND TRANSPARENT PLASTIC SUBSTRATE
21: FIRST SILICON OXIDE COATING LAYER
22: PROTECTIVE COATING LAYER
23: SECOND SILICON OXIDE COATING LAYER
32: CONDUCTIVE COATING LAYER
100: ADHESIVE LAYER

### BEST MODE

Hereinafter, one example will be described for a detailed description of the present invention. Therefore, the present invention is not limited to the following examples.

Hereinafter, physical properties measuring method are as follows in then following examples.

1) Moisture permeability: measured by the KS M3088:2004 (38±2° C., 100% R.H.) method.
Rejected: moisture permeability larger than 0.5.
Passed: moisture permeability equal to or more than 0.5.

2) UV transmittance: measured by using Varian, Cary 5000 UV-visible spectrophotometer.
UV transmittance (%) before QUV: UV transmittance is measured in the UV wavelength range (200 to 300 nm) after the antiglare coating layer made of the first transparent plastic substrate surface a UV light source after the protective film is manufactured. A value representing the highest UV transmittance in the measured range is used.

Rejected: UV transmittance larger than 2.0.

Passed: UV transmittance equal to or more than 2.0.
UV transmittance (%) after QUV: UV transmittance is measured in the UV wavelength range (200 to 300 nm) by using a UV transmittance measurer after the surface of the first transparent plastic substrate faces a light source in a QUV chamber where a lamp emitting light of a UVB wavelength is installed and is left for 100 hours after the protective film is manufactured. A value representing the highest UV transmittance in the measured range is used.

Rejected: UV transmittance larger than 2.0.

Passed: UV transmittance equal to or more than 2.0.

3) Shear storage elastic modulus

After an adhesive composition used in manufacturing the protective film is dissolved in a solvent, the adhesive composition dissolved in the solvent is applied to a Teflon sheet by a solvent casting method and the solvent is blown off to manufacture a 1 mm film with only the adhesive layer. The adhesive-layer film is laid at the center of a fixed bottom plate and a rotatable top plate by using a Pheometer (Rheometrics, RMS) to measure the variation of shearing force depending on a frequency (an angle of the top plate which moves per unit time). In this case, a strain is set to 5% and data is measured in the range of 1 to 100 radian/sec, and thereafter, a storage elastic modulus in 10 radian/sec is used as a reference value.

4) Coating thickness: measured by using a thickness measurer.

5) Appearance: After visual inspection is performed, when there is no significant abnormality in appearance, it is judged to be passed and when a wrinkle is found, it is judged to be rejected.

6) Optical transmittance of protective film: as optical transmittance, a total transmittance value measured by using the 300A model of Nippon Denshoku and when the optical transmittance of the protective film is equal to or more than 88%, it is marked to be good, when the optical transmittance of the protective film is in the range of 60 to 88%, it is marked to be normal, and when the optical transmittance of the protective film is less than 60%, it is judged to be bad.

### Example 1

Manufacture First Transparent Plastic Substrate with Antiglare Coating Layer

A polyethylene terephthalate film (Kolon, H11F) having a thickness of 188 μm and a width of 1000 mm was prepared. A composition to be used for the antiglare coating layer was manufactured by adding and mixing silicarbide (Shin-Etsu Chemical, X-52-854) of 5 parts by weight to an acrylurethane resin (DAI NIPPON PRINTING, UNIDIC 17-824-9) of 100 parts by weight. The composition was applied to one surface of the polyethylene terephthalate film and dried at 100° C. for 3 minutes and thereafter, was immediately irradiated with ultraviolet rays by using two ozone type high-pressure mercury lamps (80 W/cm, 15 cm concentration type) to form an antiglare coating layer having a thickness of 5 μm.

Manufacture Second Transparent Plastic Substrate with First Silicon Oxide Coating Layer

A SiO_{1.5} coating layer having a thickness 500 Å was formed on a polyethylene terephthalate film (Kolon, FQ00) having a thickness of 12 μm and a width of 1000 mm by using a vacuum deposition method.

Prepare Adhesive Composition

A solid of an isocyanate crosslinker (SOKEN, E-AX) of 0.3 parts by weight is added to the solid of the acrylic adhesive agent (SOKEN, SK2094R), benzotriazole (Ciba, Tinuvin 1130) of 1 part by weight was used as a UV screening agent, and methylethylketone was mixed so that the solid of the solution was 20% to prepare the adhesive composition.

Manufacture Protective Film

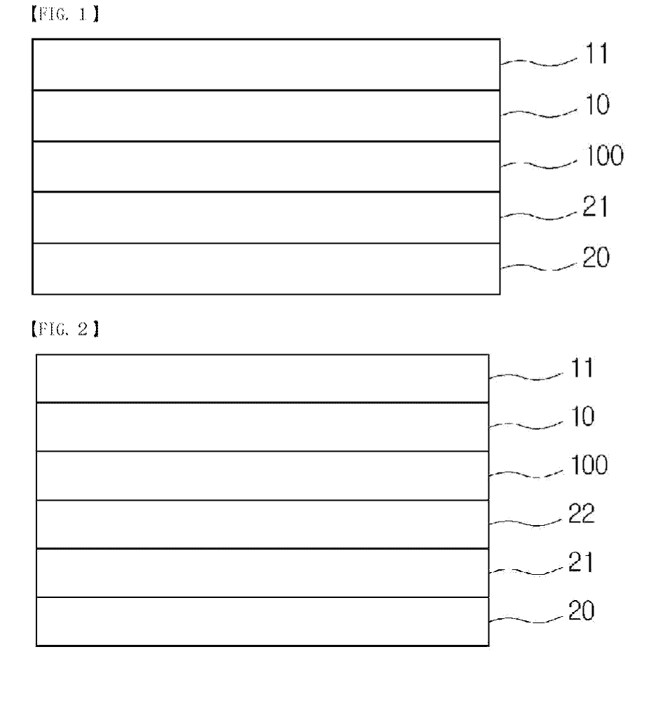

As shown in FIG. 1, a surface on which the first oxide coating layer of the second transparent plastic substrate was formed was coated with the adhesive composition and was dried at 100° C. for 3 minutes to form the adhesive layer having a dry coating thickness of 50 μm. Thereafter, the surface was bonded to a surface opposite to the surface on which the antiglare coating layer of the first transparent plastic substrate is formed.

Physical properties ware measured by using the protective film manufactured as above and the measured results were shown in Table 1.

### Example 2

As shown in FIG. 2, Example 2 manufactured the protective film similar to the same as Example 1 other than the protective coating layer having a thickness of 0.2 μm was further formed between the first silicon oxide coating layer and the adhesive layer.

Describing in detail, as the second transparent plastic substrate, a polyethyleneterephthalate film (Kolon, product name FQ00) having a thickness of 12 μm and a width of 1000 mm was prepared and the first silicon oxide (SiO_{1.5}) coating layer having a thickness of 500 Å was formed on one surface of the polyethyleneterephthalate film by the vacuum deposition method. The acrylic resin (Aekyung Chemical, A-111-50) as a solution having 8% of solid diluted with a toluene solvent was coated on the first silicon oxide coating layer. The coated film was dried at 120° C. for 30 seconds to form the protective coating layer having a dry coating thickness of 0.2 μm.

Thereafter, the adhesive composition was coated on a surface on which the first silicon oxide coating layer and the protective coating layer of the second transparent plastic substrate were formed and was then dried at 100° C. for 3 minutes to form the adhesive layer having a dry coating thickness of 50 μm and bonded the adhesive layer to the surface opposite to the surface on which the antiglare coating layer of the first transparent plastic substrate was formed.

Physical properties ware measured by using the protective film manufactured as above and the measured results were shown in Table 1.

### Example 3

Example 3 manufactured the protective film in the same method as Example 1 other than 2 parts by weight of antioxidant (Ciba, Irganox 1010) is added at the time of preparing the first adhesive composition of Example 1.

Physical properties ware measured by using the protective film manufactured as above and the measured results were shown in Table 1.

### Example 4

Manufacture First Transparent Plastic Substrate with Antiglare Coating Layer

A polyethylene terephthalate film (Kolon, H11F) having a thickness of 188 μm and a width of 1000 mm was prepared. A composition to be used for the antiglare coating layer was manufactured by adding and mixing silicarbide (Shin-Etsu Chemical, X-52-854) of 5 parts by weight to an acrylurethane resin (DAI NIPPON PRINTING, UNIDIC 17-824-9) of 100 parts by weight. The composition was applied to one surface of the polyethylene terephthalate film and dried at 100° C. for 3 minutes and thereafter, was immediately irradiated with ultraviolet rays by using two ozone type high-pressure mercury lamps (80 W/cm, 15 cm concentration type) to form an antiglare coating layer having a thickness of 5 μm.

Manufacture Second Transparent Plastic Substrate with First Silicon Oxide Coating Layer and Second Silicon Oxide Coating Layer

A SiO_{1.5} coating layer having a thickness 500 Å was formed on both surfaces of a polyethylene terephthalate film (Kolon, FQ00) having a thickness of 12 μm and a width of 1000 mm by using a vacuum deposition method.

Prepare Adhesive Composition

A solid of an isocyanate crosslinker (SOKEN, E-AX) of 0.3 parts by weight is added, for 100 parts by weight of solid of the acrylic adhesive agent (SOKEN, SK2094R), benzotriazole (SHIBA, Tinuvin 1130) of 1 part by weight was used as a UV screening agent, and methylethylketone was mixed so that the solid of the solution was 20% to prepare the adhesive composition.

Manufacture of Protective Film

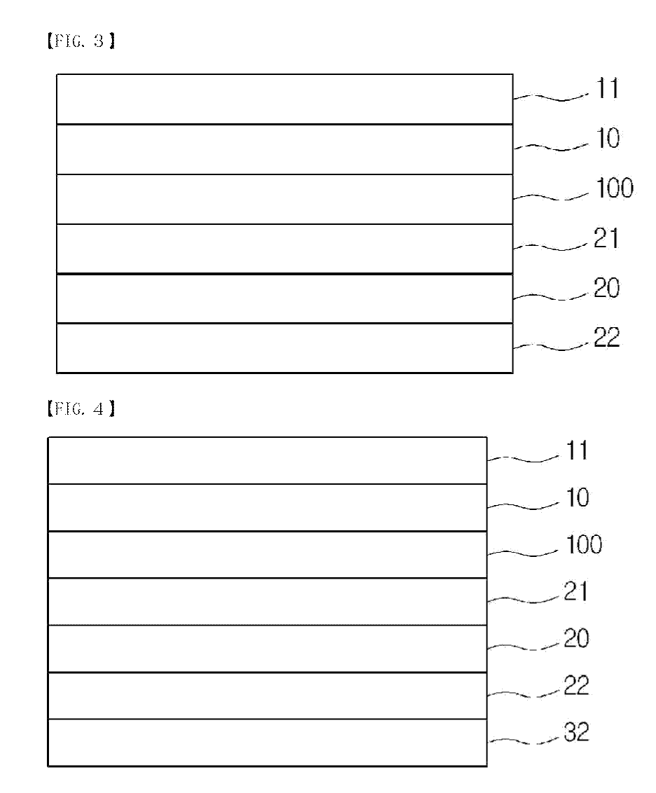

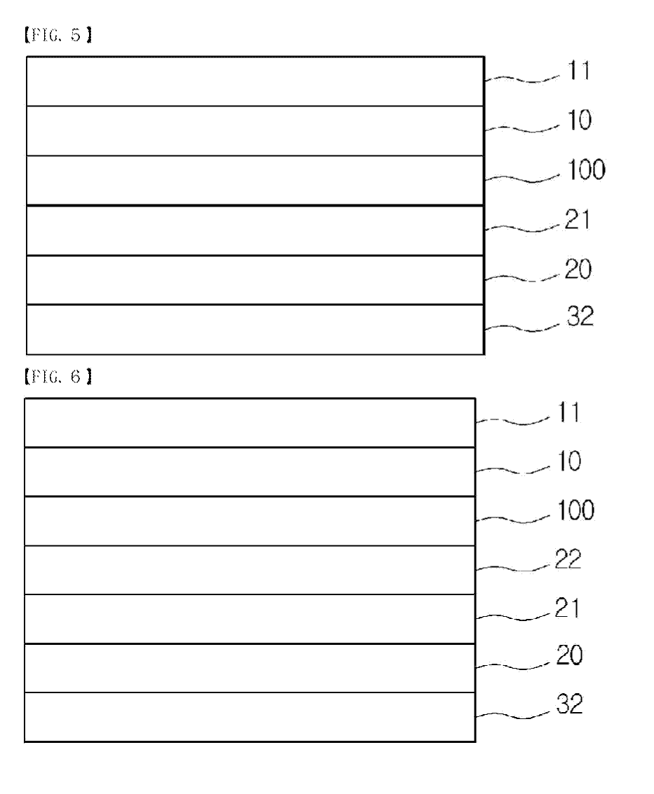

As shown in FIG. 3, the second transparent plastic substrate having the silicon oxide coating layer formed on both surfaces thereof and the first transparent plastic substrate formed with the antiglare layer were bonded to each other by the adhesive composition.

In detail, the adhesive composition was coated on the first silicon oxide coating layer of the second transparent plastic substrate having the first silicon oxide coating layer and the second silicon oxide coating layer formed on both surfaces thereof and was then dried at 100° C. for 2 minutes to form the adhesive layer having a dry coating thickness of 50 μm. The adhesive layer was bonded to a surface on which the antiglare layer of the first transparent plastic substrate is not formed.

Physical properties ware measured by using the protective film manufactured as above and the measured results were shown in Table 1.

### Example 5

Example 5 manufactured the protective film in the same method as Example 4 other than 2 parts by weight of antioxidant (Siba, Irganox 1010) is added at the time of preparing the adhesive composition of Example 4.

Physical properties ware measured by using the protective film manufactured as above and the measured results were shown in Table 1.

### Example 6

Example 6 manufactured the protective film in the same method as Example 4 other than the coating thickness of the adhesive layer is 100 μm at the time of preparing the protective film of Example 4.

### Example 7

Example 7 manufactured the protective film in the same method as Example 4 other than the coating thickness of the adhesive layer is 10 μm at the time of preparing the protective film of Example 4.

### Example 8

Example 8 manufactured the protective film in the same method as Example 4 other than the coating thickness of the adhesive layer is 200 μm at the time of preparing the protective film of Example 4.

### Example 9

Example 9 manufactured the protective film in the same method as Example 4 other than the conductive coating layer is further formed.

In detail, the indium tin oxide (ITO) was coated on the surface, on which the second silicon oxide coating layer of the protective film manufactured in Example 4 was deposited, at a thickness of 500 Å by the sputtering method to form the conductive coating layer. The results measuring physical properties were shown in the following Table 1.

### Example 10

Example 10 manufactured the protective film in the same method as Example 9 other than 2 parts by weight of antioxidant (Siba, Irganox 1010) is added at the time of preparing the adhesive composition of Example 9.

### Example 11

Example 11 manufactured the protective film in the same method as Example 9 other than the coating thickness of the adhesive layer is 100 μm at the time of preparing the protective film of Example 9.

### Example 12

Example 12 manufactured the protective film in the same method as Example 9 other than the coating thickness of the adhesive layer is 10 μm at the time of preparing the protective film of Example 9.

### Example 13

Example 13 manufactured the protective film in the same method as Example 9 other than the coating thickness of the adhesive layer is 200 μm at the time of preparing the protective film of Example 9.

### Example 14

Example 14 manufactured the protective film in the same method as Example 9 other than the ITO is 100 Å at the time of preparing the protective film of Example 9.

### Example 15

Example 15 manufactured the protective film in the same method as Example 9 other than the ITO is 1500 Å at the time of preparing the protective film of Example 9.

### Comparative Example 1

Comparative Example 1 manufactured the protective film in the same method as Example 1 other than the silicon oxide coating layer is not present. Physical properties ware measured by using the protective film manufactured as above and the measured results were shown in Table 1.

### Comparative Example 2

Comparative Example 2 manufactured the protective film in the same method as Example 1 other than the depositing layer of the second transparent plastic substrate is aluminum oxide (Al₂O₃). Physical properties ware measured by using the protective film manufactured as above and the measured results were shown in Table 1.

### Comparative Example 3

Comparative Example 3 manufactured the protective film in the same method as Example 4 other than the silicon oxide layer is not present. Physical properties ware measured by using the protective film manufactured as above and the measured results were shown in Table 1.

### Comparative Example 4

Comparative Example 4 manufactured the sample in the same method as Example 4 other than the depositing layer of the second transparent plastic substrate is aluminum oxide (Al₂O₃). Physical properties ware measured by using the protective film manufactured as above and the measured results were shown in Table 1.

### Comparative Example 5

Comparative Example 5 manufactured the protective film in the same method as Example 9 other than the silicon oxide layer is not present. Physical properties ware measured by using the protective film manufactured as above and the measured results were shown in Table 1.

### Comparative Example 6

Comparative Example 6 manufactured the sample in the same method as Example 9 other than the depositing layer of the second transparent plastic substrate is aluminum oxide (Al₂O₃). Physical properties ware measured by using the protective film manufactured as above and the measured results were shown in Table 1.

TABLE 1

| | | UV | UV | | Light |
|---|---|---|---|---|---|
| | Moisture | transmittance | transmittance | | Transmittance |
| | Permeability | before QUV | after QUV | | of Protective |
| | (g/m² day) | (max. %) | (max. %) | Appearance | Film (%) |
| Example 1 | 0.5 or less | 1.0 ± 0.2 | 1.5 ± 0.2 | Good | Good |
| Example 2 | 0.2 ± 0.2 | 1.0 ± 0.2 | 1.5 ± 0.2 | Good | Good |
| Example 3 | 0.5 or less | 1.0 ± 0.2 | 1.5 ± 0.2 | Good | Good |
| Example 4 | 0.05 or less | 1.0 ± 0.2 | 1.5 ± 0.2 | Good | Good |
| Example 5 | 0.06 or less | 0.9 ± 0.2 | 1.2 ± 0.2 | Good | Good |
| Example 6 | 0.04 or less | 0.4 ± 0.2 | 1.0 ± 0.2 | Good | Good |
| Example 7 | 0.05 or less | 1.7 ± 0.2 | 1.9 ± 0.2 | Good | Good |
| Example 8 | 0.05 or less | 0.2 ± 0.2 | 0.5 ± 0.2 | Good | Good |
| Example 9 | 0.04 or less | 1.0 ± 0.2 | 1.6 ± 0.2 | Good | Good |
| Example 10 | 0.05 or less | 0.9 ± 0.2 | 1.4 ± 0.2 | Good | Good |
| Example 11 | 0.04 or less | 0.4 ± 0.2 | 1.0 ± 0.2 | Good | Good |
| Example 12 | 0.05 or less | 1.7 ± 0.2 | 1.9 ± 0.2 | Good | Good |
| Example 13 | 0.05 or less | 0.2 ± 0.2 | 0.5 ± 0.2 | Good | Good |
| Example 14 | 0.05 or less | 1.1 ± 0.2 | 1.8 ± 0.2 | Good | Good |
| Example 15 | 0.05 or less | 1.0 ± 0.2 | 1.6 ± 0.2 | Good | Good |
| Comparative | 3.0 ± 0.5 | 1.0 ± 0.2 | 1.7 ± 0.2 | Good | Good |
| Example 1 | | | | | |
| Comparative | 1.0 ± 0.4 | 1.0 ± 0.2 | 1.6 ± 0.2 | Good | Good |
| Example 2 | | | | | |
| Comparative | 2.1 ± 0.2 | 1.0 ± 0.2 | 1.6 ± 0.2 | Good | Good |
| Example 3 | | | | | |
| Comparative | 0.6 ± 0.2 | 1.5 ± 0.2 | 1.7 ± 0.2 | Good | Good |
| Example 4 | | | | | |
| Comparative | 2.0 ± 0.2 | 1.3 ± 0.2 | 1.6 ± 0.2 | Good | Good |
| Example 5 | | | | | |
| Comparative | 0.6 ± 0.2 | 1.5 ± 0.2 | 1.7 ± 0.2 | Good | Good |
| Example 6 | | | | | |

As shown in the above table, in the example of the present invention, since the protective film has low moisture permeability, it has an excellent vapor barrier property. Further, in Example 2, it could be appreciated that when the protective coating layer is added, physical properties are further improved. In addition, it could be appreciated that the UV transmittance is further lowered by adding the antioxidant to the adhesive composition. Further, it could be appreciated that when the conductive coating layer is formed, the touch screen is implemented.

However, in the case of the comparative examples without the silicon oxide layer, the moisture permeability rapidly increases and when the transparent deposition layer is made of aluminum oxide, moisture permeability increases as compared with the transparent deposition layer made of silicon oxide.

Accordingly, since the protective film having the lamination sequence and thickness according to the present invention is excellent in the vapor barrier property and the UV shielding property, it can be easily applied to the protective film for the e-book and other usages.

### INDUSTRIAL APPLICABILITY

The protective film according to the present invention can be used for various purposes of display devices, such as home appliances, vehicles, communication devices, PDAs, and the like, in addition to the e-book.

Further the protective film of the present invention can be applied to a touch screen type e-book.

1. A protective film, comprising:
an antiglare coating layer formed on one surface of a first transparent plastic substrate;
a first silicon oxide (SiOx, x is 1.0 to 2.0) coating layer formed on one surface of a second transparent plastic substrate; and
an adhesive layer having the first transparent plastic substrate and the first silicon oxide coating layer disposed to be opposite to each other thereon and bonded to each other therethrough.

2. The protective film of claim 1, further comprising a protective coating layer of acrylic resin formed between the first silicon oxide coating layer and the adhesive layer.

3. The protective film of claim 2, wherein the protective coating layer is coated at a thickness of 0.01-5 μm.

4. The protective film of claim 1, wherein the upper portion of the second transparent plastic substrate is further provided with a conductive coating layer.

5. The protective film of claim 1, wherein the second transparent plastic substrate further includes a second silicon oxide coating layer formed on a surface opposite to the surface on which the first silicon oxide coating layer is formed.

6. The protective film of claim 5, further comprising a conductive coating layer formed on the upper portion of the second silicon oxide coating layer.

7. The protective film of claim 6, wherein the conductive coating layer is coated with indium tin oxide (ITO) at a thickness of 200 to 1000 Å by a method selected from a sputtering method, a vacuum deposition method, an ion plating method, a coating method, a solution coating method, and a powder coating method.

8. The protective film of claim 1, wherein the first silicon oxide coating layer is coated at a thickness of 300 to 1000 Å by the vacuum deposition method.

9. The protective film of claim 1, wherein the antiglare coating layer is coated at a dry coating thickness of 3 to 5 μm by using a composition in which silicon bead is added to urethane acrylate-based resin

10. The protective film of claim 1, wherein the adhesive layer is coated at a dry coating thickness of 30 to 60 μm by using an acrylate-based adhesive composition including a UV screening agent.

11. The protective film of claim 10, wherein the adhesive layer has 90% of light transmittance, 1% or less of Haze, and 103-1O5 Pa of shear storage elastic modulus.

12. The protective film of claim 10, wherein the adhesive composition includes a triazole-based UV screening agent.

13. The protective film of claim 12, wherein the adhesive composition further includes any one or a mixture of two or more selected from a triazine-based UV screening agent, an antioxidant, a heat stabilizer, and a fluorescent whitening agent.

14. The protective film of claim 1, wherein the thickness of the first transparent plastic substrate is 50 to 250 μm and the thickness of the second transparent plastic is 10 to 50 μm.

15. The protective film of claim 14, wherein the first transparent plastic substrate and the second transparent substrate is polyethyleneterephthalate or polyethylenenaphatalate having light transmittance of 90% or more.

16. The protective film of claim 2, wherein the upper portion of the second transparent plastic substrate is further provided with a conductive coating layer.

17. The protective film of claim 5, wherein the second silicon oxide coating layer is coated at a thickness of 300 to 1000 Å by the vacuum deposition method.
